(19) United States
(12) Patent Application Publication
(10) Pub. No.: US 2004/0090137 A1
(43) Pub. Date: May 13, 2004

(54) Immersed electric motor and procedure for its manufacture

(76) Inventor: Markus Bildstein, Oberstaufen (DE)

Correspondence Address: Rocco S. Barrese, Esq., DILWORTH & BARRESE, LLP, 333 Earle Ovington Blvd., Unionadale, NY, 11553, US

(21) Appl. No.: 10/621,792

(22) Filed: Jul. 17, 2003

(30) Foreign Application Priority Data
Jul. 17, 2002 (DE) 102 32 389.5

(51) Int. Cl. H02K 5/10; H02K 5/12

(52) U.S. Cl. 310/214; 29/596; 310/87

(57) ABSTRACT

The invention relates to an immersed electric motor with a rotor, a stator with pole shoes, and a plastic casing positioned between the rotor and stator. According to the invention, filler pieces are positioned between the pole shoes in such a way that the filler pieces are in contact with one another forming a closed bore that serves as a support for the plastic casing.

This type of electric motor has a rotor, a stator with pole shoes, and a plastic casing positioned between the rotor and stator. When the inductance is modified with known motors, a well-known method is to increase the inductance by superposing choking coils. But this results in a heavier motor. In addition, more space is required and the reliability of the motor is reduced.

The task of the invention is to further develop an immersed motor of this type so that the plastic casing can be backed up by the stator in such a way that it can be subjected hydraulically to high internal pressure without being damaged. Moreover, it is intended to be possible to modify the inductance of the motor without affecting the weight, space, and reliability of the motor.

Starting from an immersed electric motor a rotor, a stator with pole shoes, and a plastic casing positioned between the rotor and stator, this task is solved according to the invention in that filler pieces are positioned between the pole shoes in such a way that these filler pieces are in contact with one another to form a closed bore that serves as a support for the plastic casing. In this way an even support for the plastic casing is provided by the support bore, so that internal pressures of 350 bar can easily impinge on the plastic casing without damaging it.

Advantageous embodiments of the invention are found in the subclaims following the main claim.

Accordingly, the filler pieces may be manufactured of layers of electrically insulated plates. Eddy currents can be hereby reduced in an advantageous manner.

Thin, electrically insulating foils can also be positioned advantageously between the filler pieces and stator poles. These can be made out of Kapton, for example, and can have a thickness of about 0.075 mm. In this way, eddy currents are further reduced.

According to a particularly advantageous embodiment, the filler pieces are manufactured from plates of varying magnetic conductivity. In this way a predetermined desired motor inductance can be achieved.

Another advantageous embodiment of the invention includes that the filler pieces have lateral recesses, which interlock with corresponding projections on the pole shoes, in order to guarantee a radial form closure. The filler pieces can be held fast by this radial form closure with the stator so that they do not fall out during assembly.

The layers made of plates forming the pole shoes can have varying plate thicknesses so that, through a suitable combination of different plate thicknesses, the filler piece length can be approximated to the length of the stator without the need for refinishing to modify the plate thickness.

A procedure, according to the invention, for manufacturing the aforementioned immersed electric motor is given claim 6. Particularly advantageous embodiments of this procedure are given in the subsequent claims 7 to 9.

Using the manufacturing procedure according to the invention, the plates for making the filler pieces can be put in place during their assembly using profiled plates. The profiled plates consist of a ring-shaped support body and individual plates of each filler piece. After positioning, the ring-shaped support bodies are removed from the individual plates.

Coil-impregnating resin and/or coil-filling resin can be advantageously poured into the gap between the form pieces and the pole shoes during and/or after the removal of the support bodies, which will guarantee that the filler pieces are firmly fixed in their position.

In order to guarantee a radially outward-directed metallic contact between the filler pieces and the pole shoes, which is advantageous for the support effect, the support bodies are expanded before the penetration by the resin.

In order to reduce the inward-directed force as a result of the backspringing of the support bodies, the support bodies are deformed in such a way that they remain plastically deformed after their expansion. This is aided in particular by a suitable shaping of the support bodies, namely the selection of a small thickness, for example.

Additional details and advantageous of the invention are described based on one of the design embodiments depicted in the drawings:

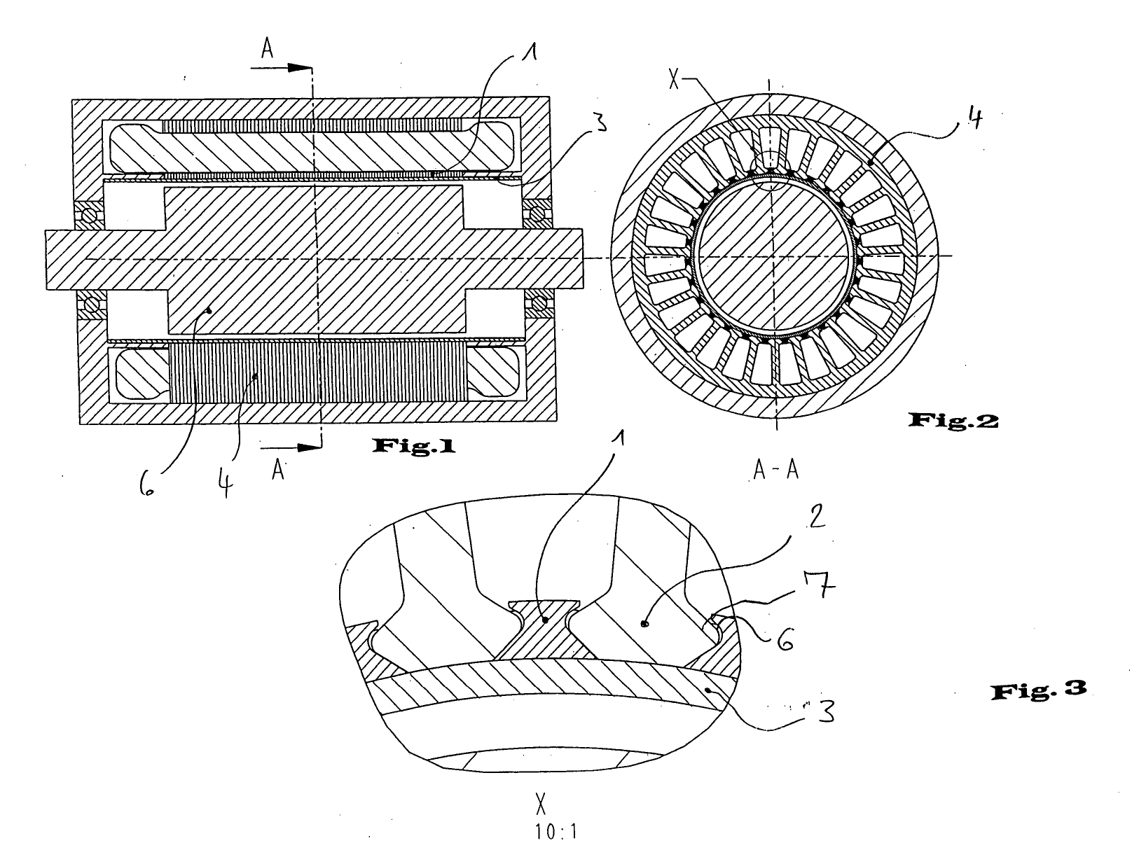

FIG. 1 shows a longitudinal section through a design embodiment of an immersed electric motor according to the present invention,

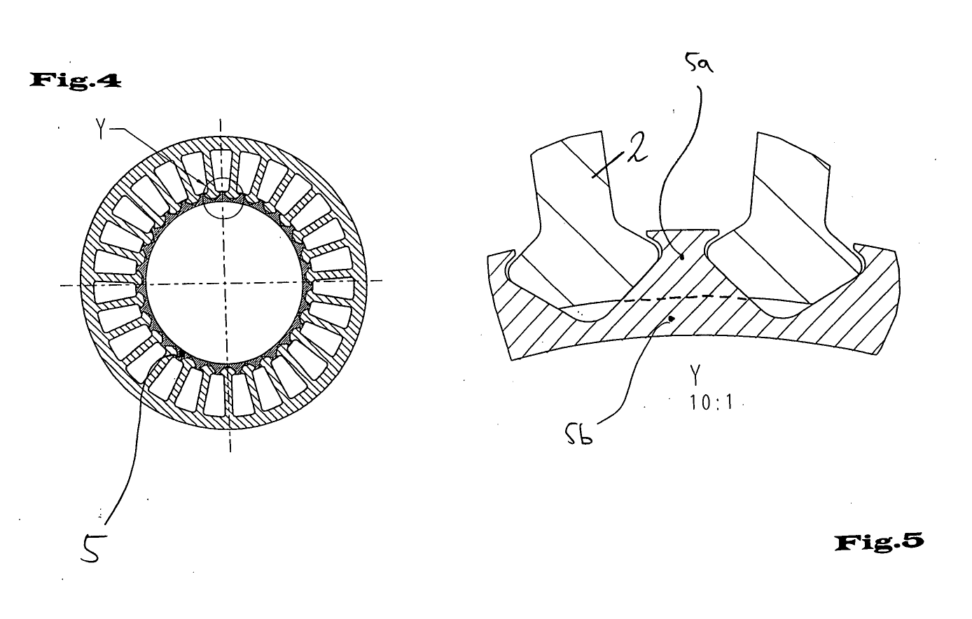

FIG. 2 shows a section along line A-A in FIG. 1,

FIG. 3 shows an enlargement of Detail X in FIG. 2,

FIG. 4 shows a section along line A-A through the motor of FIG. 1, but prior to assembly, and

FIG. 5 shows Detail Y of FIG. 4.

FIG. 1 depicts an immersed electric motor such as is already known in its fundamental structure. It has a rotor 6, a stator 4, and a plastic casing 3.

In the detailed depiction in FIG. 3, it can be seen that the position of pole shoes 2 is essentially determined by the shaping of stator 4. Filler pieces 1, which are positioned between the pole shoes, have corresponding recesses 6 [sic], and pole shoes 2 have projections 7 that interlock with the respective recesses. The filler pieces and recesses result overall in a closed bore in which plastic casing 3 is evenly supported. Plastic casing 3 can hereby withstand high pressures, since these pressures are transferred to the surface formed by pole shoes 2 and filler pieces 1.

A procedure for manufacturing an electric motor with filler pieces 1 according FIG. 3 can be explained based on FIGS. 4 and 5. According to it, the stator with its pole shoes 2 is embedded in a form plate 5, with form plate 5 consisting of a lower section, namely a ring-shaped support body 5b, and an upper section, namely the individual plates 5a. Individual plates 5a correspond to eventual filler pieces 1. After appropriate positioning of form plate 5, ring-shaped support body 5b is separated from individual plates 5a, so that form plate 5 is detached during, or else after, the removal of the support body, coil-impregnating resin and/or coil-filling resin can be poured into the gap between form pieces 1 and pole shoes 2.

Electric motors according to the present invention can be used for any number of applications. They can be used especially advantageously for electrohydraulic drives for aircraft steering actuators.

1. Immersed electric motor with a rotor (6), a stator(4) with pole shoes (2), and a plastic casing (3) positioned between rotor (6) and stator (4),
characterized in that,
filler pieces (1) are positioned between the pole shoes (2) in such a way that the filler pieces are in contact with one another forming a closed bore that serves as a support for the plastic casing (3).

2. Electric motor of claim 1, characterized in that the filler pieces (1) are made out of layers of electrically insulated plates.

3. Electric motor of claim 1 or 2, characterized in that the filler pieces (1) are made out of plates of varying magnetic load capacity.

4. Electric motor of claim one of the claims 1 to 3, characterized in that filler pieces (1) have lateral recesses (6) that are interlocked interlock with corresponding projections (7) of the pole shoes (2) in order to guarantee a radial form closure.

5. Electric motor of claim [[one of the claims 2 to 4 characterized in that the layers made of plates that form the pole shoes (2) have varying plate thicknesses.

6. Procedure for manufacturing an electric motoraccording to claims 1 to 5, characterized in that the plates for making filler pieces (1) are put in place during their assembly using profiled plates (5), with the prefilled plate that connects one individual plate (5a) of each filler piece (1) to one ring-shaped support body (5b) being separated from individual plates (5a) after positioning by removing ring-shaped support body (5b).

7. Procedure according to claim 6, characterized in that coil-impregnating resin and/or coil-filling resin is poured into the gap between form pieces (1) and pole shoes (2) during and/or after the removal of support bodies (5b).

8. Procedure according to claim 6 or claim 7, characterized in that support bodies (5b) are expanded prior to penetration by the resin.

9. Procedure according to claim 8, characterized in that support bodies (5b) are plastically deformed after being expanded.
